(19) United States
(12) Patent Application Publication
(10) Pub. No.: US 2022/0232597 A1
(43) Pub. Date: Jul. 21, 2022

(54) TECHNIQUES FOR CROSS-CARRIER SCHEDULING WITH MULTI-TRANSMISSION AND RECEPTION POINTS AND DYNAMIC SPECTRUM SHARING

(71) Applicant: QUALCOMM Incorporated, San Diego, CA (US)

(72) Inventors: Kazuki TAKEDA, Tokyo (JP); Mostafa KHOSHNEVISAN, San Diego, CA (US)

(21) Appl. No.: 17/520,347

(22) Filed: Nov. 5, 2021

Related U.S. Application Data
(60) Provisional application No. 63/139,563, filed on Jan. 20, 2021.

(51) Int. Cl. H04W 72/12

(52) U.S. Cl. CPC H04W 72/1273; H04W 72/1257; H04W 72/1278

(57) ABSTRACT

Techniques for cross-carrier scheduling with multi-transmission and reception points (multi-TRP) and dynamic spectrum sharing (DSS) may be performed. In an example, a user equipment (UE) may be configured according to configuration information for cross-carrier scheduling between a secondary cell (Scell) and one of a primary cell (Pcell) or a primary Scell (PScell). The UE may receive a first physical downlink control channel (PDCCH) on the Scell and a second PDCCH on the one of the Pcell or the PScell. The UE may also determine data scheduling for the one of the Pcell or the PScell for simultaneous reception of physical downlink scheduling channels (PDSCHs) and out-of-order PDSCHs or PUSCHs associated with the first PDCCH and the second PDCCH, based on the configuration information. The UE may also receive data on the one of the Pcell or the PScell according to the determining of the data scheduling.

### CROSS-REFERENCE TO RELATED APPLICATION(S)

This application claims the benefit of U.S. Provisional Application No. 63/139,563, entitled “TECHNIQUES FOR CROSS-CARRIER SCHEDULING WITH MULTI-TRANSMISSION AND RECEPTION POINTS AND DYNAMIC SPECTRUM SHARING” and filed on Jan. 20, 2021, which is expressly incorporated by reference herein in its entirety.

### BACKGROUND

Aspects of the present disclosure relate generally to wireless communications, and more particularly, to techniques for cross-carrier scheduling with multi-transmission and reception points (TRPs) and dynamic spectrum sharing (DSS).

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

### SUMMARY

Systems, methods, and apparatus presented herein each have several innovative aspects, no single one of which is solely responsible for the desirable attributes disclosed herein. The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of wireless communication by a user equipment (UE) is provided. The method may include configuring the UE according to configuration information for cross-carrier scheduling between a secondary cell (Scell) and one of a primary cell (Pcell) or a primary Scell (PScell). The method may include receiving a first physical downlink control channel (PDCCH) on the Scell and a second PDCCH on the one of the Pcell or the PScell. The method may include determining data scheduling for the one of the Pcell or the PScell for simultaneous reception of physical downlink scheduling channels (PDSCHs) and out-of-order PDSCHs or PUSCHs associated with the first PDCCH and the second PDCCH, based on the configuration information. The method may include receiving data on the one of the Pcell or the PScell according to the determining of the data scheduling.

In another aspect, a method of wireless communication by a base station is provided. The method may include transmitting, to a UE, configuration information for cross-carrier scheduling between a Scell and one of a Pcell or a PScell. The method may include determining data scheduling for the one of the Pcell or the PScell for simultaneous reception of PDSCHs and out-of-order PDSCHs or PUSCHs, based on the configuration information. The method may include transmitting data on the one of the Pcell or the PScell according to the determining of the data scheduling.

In other aspects, apparatuses and computer-readable mediums for performing these methods are provided.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network, according to aspects of the present disclosure;

FIG. 2 is a schematic diagram of an example of a user equipment (UE) of FIG. 1, according to aspects of the present disclosure;

FIG. 3 is a schematic diagram of an example of a base station of FIG. 1, according to aspects of the present disclosure;

FIG. 4 is a block diagram of example scheduling techniques, according to aspects of the present disclosure

FIG. 5 is a block diagram of an example technique for carrier scheduling, according to aspects of the present disclosure;

FIG. 6 is a block diagram of simultaneous reception and out-of-order scheduling, according to aspects of the present disclosure;

FIG. 7 is a block diagram of an example of a cross-carrier scheduling, according to aspects of the present disclosure;

FIG. 8 is a block diagram of another example of cross-carrier scheduling, according to aspects of the present disclosure;

FIG. 9 is flow diagram of an example method performed by a user equipment (UE) of FIG. 1, according to aspects of the present disclosure; and

FIG. 10 is flow diagram of an example method performed by a base station of FIG. 1, according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Conventional methods of scheduling physical downlink (DL) shared channels (PDSCHs) or physical uplink (UL) shared channels (PUSCHs) may not allow for simultaneous reception of multiple PDSCHs or out-of-order scheduling on the same serving cell.

Aspects of the present disclosure overcome the deficiencies of conventional methods by providing techniques for multi-TRP and cross-carrier sharing. In an example, a user equipment (UE) may be configured according to configuration information for cross-carrier scheduling between a secondary cell (Scell) and one of a primary cell (Pcell) or a primary Scell (PScell). The UE may receive a first physical downlink control channel (PDCCH) on the Scell and a second PDCCH on one of the Pcell or the PScell. The UE may schedule data for one of the Pcell or the PScell for simultaneous reception of PDSCHs and out-of-order PDSCHs or PUSCHs associated with the first PDCCH and the second PDCCH, based on the configuration information. The UE may then receive data on the one of the Pcell or the PScell according to the scheduling of the data.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Turning now to the figures, examples of systems, apparatus, and methods according to aspects of the present disclosure are depicted. It is to be understood that aspects of the figures may not be drawn to scale and are instead drawn for illustrative purposes.

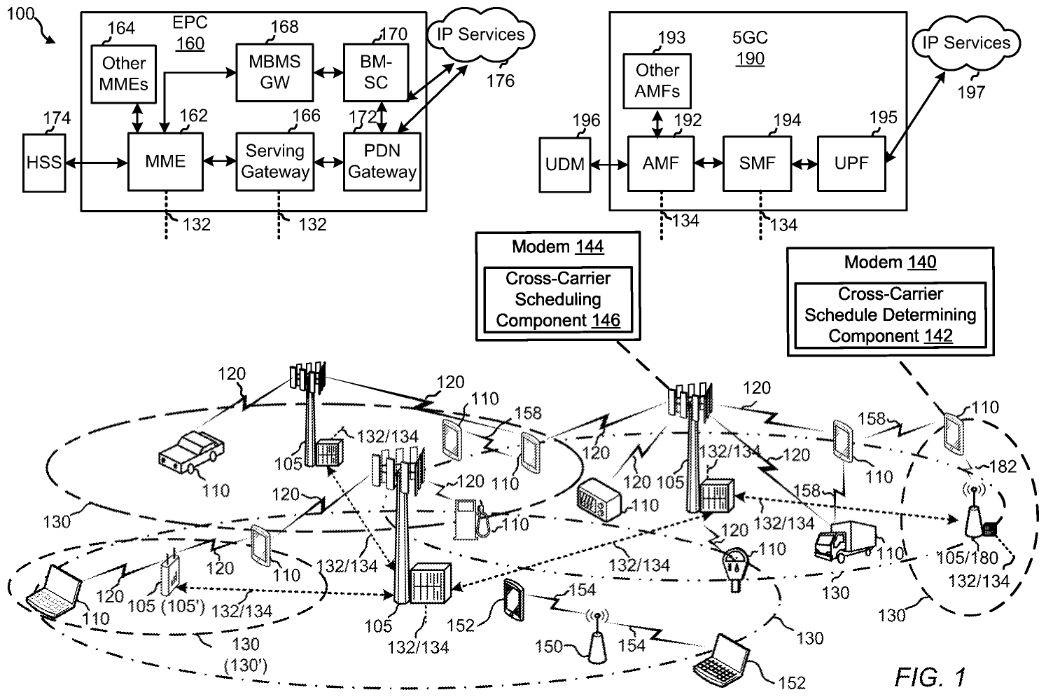

FIG. 1 is a diagram illustrating an example of a wireless communications system and an access network 100. The wireless communications system (also referred to as a wireless wide area network (WWAN)) includes at least one base station 105, UEs 110, an Evolved Packet Core (EPC) 160, and a 5G Core (5GC) 190. The base station 105 may include macro cells (high power cellular base station) and/or small cells (low power cellular base station). The macro cells include base stations. The small cells include femtocells, picocells, and microcells.

In some implementations, UEs 110 may include a modem 140 and/or a cross-carrier schedule determining component 142 for determining scheduling for cross-carrier PDSCHs or PUSCHs according to configuration information, from, for example, the base station 105. In some implementations, base station 105 may include a modem 144 and/or a cross-carrier scheduling component 146 for configuring cross-carrier PDSCHs or PUSCHs on the UE according to configuration information.

A base station 105 may be configured for 4G LTE (collectively referred to as Evolved Universal Mobile Telecommunications System (UMTS) Terrestrial Radio Access Network (E-UTRAN)) may interface with the EPC 160 through backhaul links interfaces 132 (e.g., S1, X2, Internet Protocol (IP), or flex interfaces). A base station 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the base station 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base station 105 may communicate directly or indirectly (e.g., through the EPC 160 or 5GC 190) with each other over the backhaul links interfaces 134. The backhaul links 132, 134 may be wired or wireless.

The base station 105 may wirelessly communicate with the UEs 110. Each of the base station 105 may provide communication coverage for a respective geographic coverage area 130. There may be overlapping geographic coverage areas 130. For example, the small cell 105′ may have a coverage area 130′ that overlaps the coverage area 130 of one or more macro base station 105. A network that includes both small cell and macro cells may be known as a heterogeneous network. A heterogeneous network may also include Home Evolved Node base station (eNBs) (HeNBs), which may provide service to a restricted group known as a closed subscriber group (CSG). The communication links 120 between the base station 105 and the UEs 110 may include UL (also referred to as reverse link) transmissions from a UE 110 to a base station 105 and/or DL (also referred to as forward link) transmissions from a base station 105 to a UE 110. The communication links 120 may use multiple-input and multiple-output (MIMO) antenna technology, including spatial multiplexing, beamforming, and/or transmit diversity. The communication links may be through one or more carriers. The base station 105/UEs 110 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a PCell and a secondary component carrier may be referred to as an SCell.

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A base station 105, whether a small cell 105′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 110. When the gNB 180 operates in mmW or near mmW frequencies, the gNB 180 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base station 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The base station 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

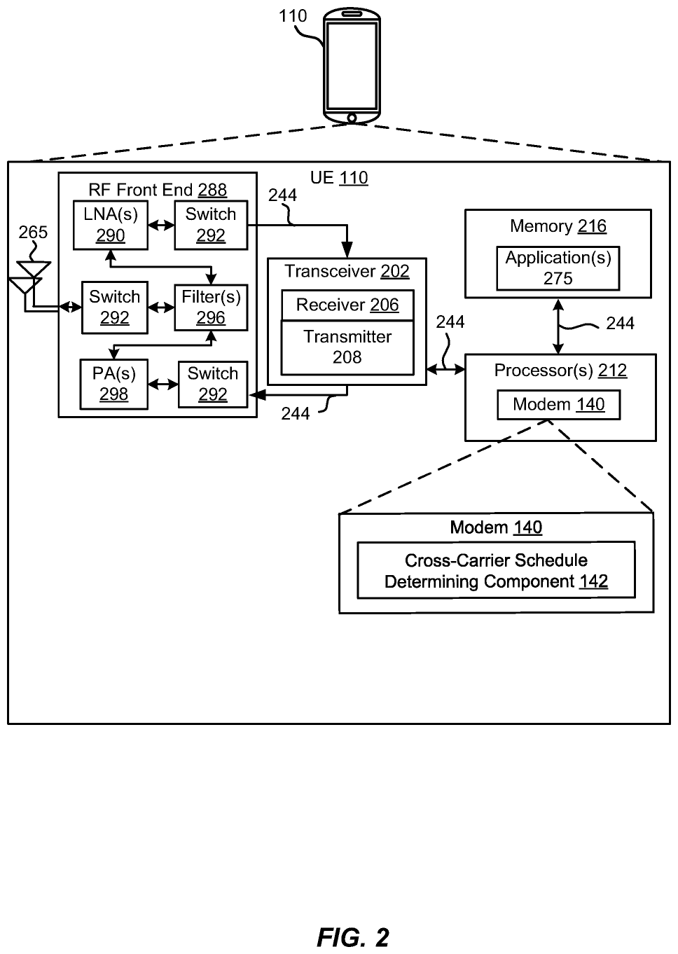

Referring to FIG. 2, an example implementation of the UE 110 may include the modem 140 having the cross-carrier schedule determining component 142. The modem 140 and/or the cross-carrier schedule determining component 142 of the UE 110 may be configured to configure the UE 110 for cross-carrier scheduling from a scheduling Scell to a Pcell/PScell and determine, based on the configuration, combinations of PDCCHs that are allowed or not allowed.

In some implementations, the UE 110 may include a variety of components, including components such as one or more processors 212 and memory 216 and transceiver 202 in communication via one or more buses 244, which may operate in conjunction with the modem 140 and/or the cross-carrier schedule determining component 142 to enable one or more of the functions described herein related to cross-carrier scheduling. Further, the one or more processors 212, modem 140, memory 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 140 that uses one or more modem processors. The various functions related to the cross-carrier schedule determining component 142 may be included in the modem 140 and/or the processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 140 may configure the UE 110 along with the processors 212. In other aspects, some of the features of the one or more processors 212 and/or the modem 140 associated with the cross-carrier schedule determining component 142 may be performed by the transceiver 202.

Also, the memory 216 may be configured to store data used herein and/or local versions of applications 275 or the cross-carrier schedule determining component 142 and/or one or more subcomponents of the cross-carrier schedule determining component 142 being executed by at least one processor 212. The memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, the memory 216 may be a non-transitory computer-readable storage medium that stores one or more computer-executable codes defining the cross-carrier schedule determining component 142 and/or one or more of its subcomponents, and/or data associated therewith, when the UE 110 is operating at least one processor 212 to execute the cross-carrier schedule determining component 142 and/or one or more of the subcomponents.

The transceiver 202 may include at least one receiver 206 and at least one transmitter 208. The receiver 206 may include hardware, firmware, and/or software code executable by a processor for receiving data, the code comprising instructions and being stored in a memory (e.g., computer-readable medium). The receiver 206 may be, for example, an RF receiving device. In an aspect, the receiver 206 may receive signals transmitted by at least one base station 105. The transmitter 208 may include hardware, firmware, and/or software code executable by a processor for transmitting data, the code comprising instructions and being stored in a memory (e.g., computer-readable medium). A suitable example of the transmitter 208 may include, but is not limited to, an RF transmitter.

Moreover, in an aspect, the UE 110 may include the RF front end 288, which may operate in communication with one or more antennas 265 and the transceiver 202 for receiving and transmitting radio transmissions, for example, wireless communications transmitted by at least one base station 105 or wireless transmissions transmitted by the UE 110. The RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, the LNA 290 may amplify a received signal at a desired output level. In an aspect, each of the LNAs 290 may have a specified minimum and maximum gain values. In an aspect, the RF front end 288 may use one or more switches 292 to select a particular LNA 290 and the specified gain value based on a desired gain value for a particular application.

Further, for example, one or more PA(s) 298 may be used by the RF front end 288 to amplify a signal for an RF output at a desired output power level. In an aspect, each of the PAs 298 may have specified minimum and maximum gain values. In an aspect, the RF front end 288 may use one or more switches 292 to select a particular PA 298 and the specified gain value based on a desired gain value for a particular application.

Also, for example, one or more filters 296 may be used by the RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, the RF front end 288 may use one or more switches 292 to select a transmit or receive path using a specified filter 296, the LNA 290, and/or the PA 298, based on a configuration as specified by the transceiver 202 and/or processor 212.

As such, the transceiver 202 may be configured to transmit and receive wireless signals through one or more antennas 265 via the RF front end 288. In an aspect, the transceiver 202 may be tuned to operate at specified frequencies such that the UE 110 may communicate with, for example, one or more of the base stations 105 or one or more cells associated with one or more of the base stations 105. In an aspect, for example, the modem 140 may configure the transceiver 202 to operate at a specified frequency and power level based on a UE configuration of the UE 110 and the communication protocol used by the modem 140.

In an aspect, the modem 140 may be a multiband-multimode modem, which may process digital data and communicate with the transceiver 202 such that the digital data is sent and received using the transceiver 202. In an aspect, the modem 140 may be multiband and be configured to support multiple frequency bands for a specific communications protocol. In an aspect, the modem 140 may be multimode and be configured to support multiple operating networks and communications protocols. In an aspect, the modem 140 may control one or more components of the UE 110 (e.g., RF front end 288, transceiver 202) to enable transmission and/or reception of signals from the network based on a specified modem configuration. In an aspect, a modem configuration may be based on the mode of the modem 140 and the frequency band in use. In another aspect, the modem configuration may be based on UE configuration information associated with the UE 110 as provided by the network (e.g., base station 105).

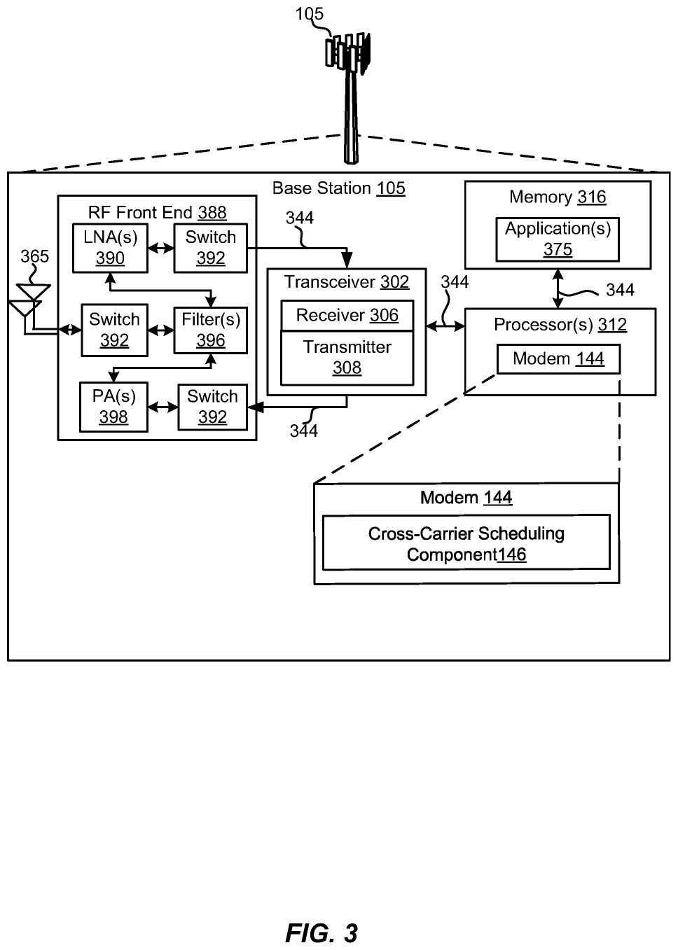

Referring to FIG. 3, an example implementation of the base station 105 may include the modem 144 with the cross-carrier scheduling component 146 configured to schedule data on the UE 110 based on cross-carrier configurations. The modem 144 and/or the cross-carrier scheduling component 146 of the base station 105 may be configured to communicate with the UE 110 via a cellular network, a Wi-Fi network, or other wireless and wired networks.

In some implementations, the base station 105 may include a variety of components, including components such as one or more processors 312 and memory 316 and transceiver 302 in communication via one or more buses 344, which may operate in conjunction with the modem 144 and the cross-carrier scheduling component 146 to enable one or more of the functions described herein related to configuring the UE 110. Further, the one or more processors 312, the modem 144, the memory 316, the transceiver 302, a RF front end 388, and one or more antennas 365, may be configured to support voice and/or data calls (simultaneously or non-simultaneously) in one or more radio access technologies. The one or more antennas 365 may include one or more antennas, antenna elements and/or antenna arrays.

In an aspect, the one or more processors 312 may include the modem 144 that uses one or more modem processors. The various functions related to the cross-carrier scheduling component 146 may be included in the modem 144 and/or the processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with the transceiver 302. Additionally, the modem 144 may configure the base station 105 and the processors 312. In other aspects, some of the features of the one or more processors 312 and/or the modem 144 associated with the cross-carrier scheduling component 146 may be performed by the transceiver 302.

Also, the memory 316 may be configured to store data used herein and/or local versions of applications 375 or the cross-carrier scheduling component 146, and/or one or more subcomponents of the cross-carrier scheduling component 146 being executed by at least one processor 312. The memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, the memory 316 may be a non-transitory computer-readable storage medium that stores one or more computer-executable codes defining the cross-carrier scheduling component 146 and/or one or more of the subcomponents, and/or data associated therewith, when the base station 105 is operating at least one processor 312 to execute the cross-carrier scheduling component 146 and/or one or more of the subcomponents.

The transceiver 302 may include at least one receiver 306 and at least one transmitter 308. The at least one receiver 306 may include hardware, firmware, and/or software code executable by a processor for receiving data, the code comprising instructions and being stored in a memory (e.g., computer-readable medium). The receiver 306 may be, for example, an RF receiving device. In an aspect, the receiver 306 may receive signals transmitted by the UE 110. The transmitter 308 may include hardware, firmware, and/or software code executable by a processor for transmitting data, the code comprising instructions and being stored in a memory (e.g., computer-readable medium). A suitable example of the transmitter 308 may include, but is not limited to, an RF transmitter.

Moreover, in an aspect, the base station 105 may include the RF front end 388, which may operate in communication with one or more antennas 365 and the transceiver 302 for receiving and transmitting radio transmissions, for example, wireless communications transmitted by other base stations 105 or wireless transmissions transmitted by the UE 110. The RF front end 388 may be coupled with one or more antennas 365 and may include one or more low-noise amplifiers (LNAs) 390, one or more switches 392, one or more power amplifiers (PAs) 398, and one or more filters 396 for transmitting and receiving RF signals.

In an aspect, the LNA 390 may amplify a received signal at a desired output level. In an aspect, each of the LNAs 390 may have a specified minimum and maximum gain values. In an aspect, the RF front end 388 may use one or more switches 392 to select a particular LNA 390 and the specified gain value based on a desired gain value for a particular application.

Further, for example, one or more PA(s) 398 may be used by the RF front end 388 to amplify a signal for an RF output at a desired output power level. In an aspect, each PA 398 may have specified minimum and maximum gain values. In an aspect, the RF front end 388 may use one or more switches 392 to select a particular PA 398 and the specified gain value based on a desired gain value for a particular application.

Also, for example, one or more filters 396 may be used by the RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, the RF front end 388 may use one or more switches 392 to select a transmit or receive path using a specified filter 396, the LNA 390, and/or the PA 398, based on a configuration as specified by the transceiver 302 and/or the processor 312.

As such, the transceiver 302 may be configured to transmit and receive wireless signals through one or more antennas 365 via the RF front end 388. In an aspect, transceiver may be tuned to operate at specified frequencies such that the base station 105 may communicate with, for example, the UE 110 or one or more cells associated with one or more base station 105. In an aspect, for example, the modem 144 may configure the transceiver 302 to operate at a specified frequency and power level based on the base station configuration of the base station 105 and the communication protocol used by the modem 144.

In an aspect, the modem 144 may be a multiband-multimode modem, which may process digital data and communicate with the transceiver 302 such that the digital data is sent and received using the transceiver 302. In an aspect, the modem 144 may be multiband and be configured to support multiple frequency bands for a specific communications protocol. In an aspect, the modem 144 may be multimode and be configured to support multiple operating networks and communications protocols. In an aspect, the modem 144 may control one or more components of the base station 105 (e.g., RF front end 388, transceiver 302) to enable transmission and/or reception of signals from the network based on a specified modem configuration. In an aspect, the modem configuration may be based on the mode of the modem 144 and the frequency band in use. In another aspect, the modem configuration may be based on a base station configuration associated with the base station 105.

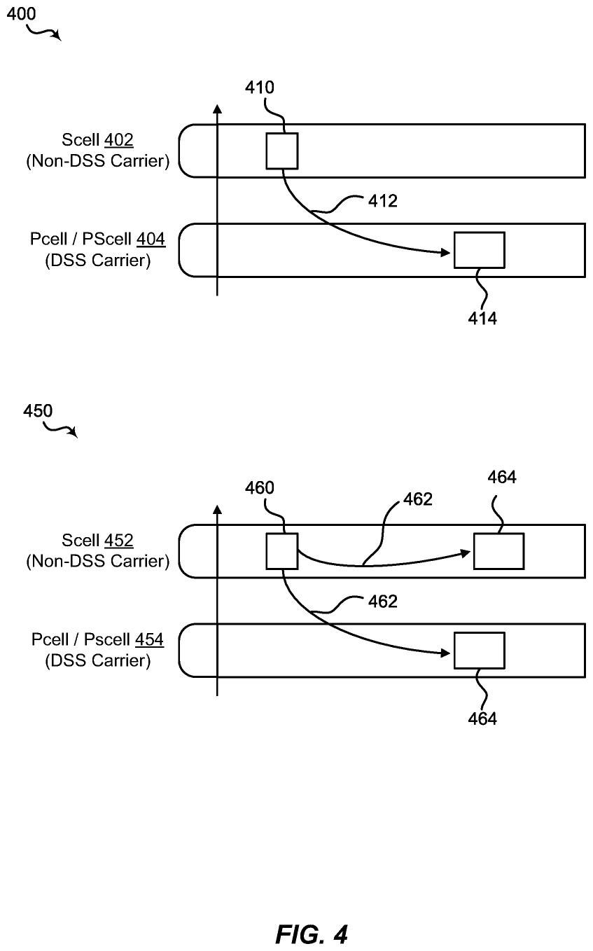

Referring to FIG. 4, for new radio (NR) Dynamic Spectrum Sharing (DSS), PDCCH enhancements for cross-carrier scheduling may include, in a first conceptual example 400, a PDCCH of an Scell 402 cross-carrier scheduling 412 of a PDSCH 414 (or PUSCH) on a Pcell 404 (or a PScell) (cumulatively referred to as a Pcell/PScell through-out this disclosure) using a DL control information (DCI) 410. PDCCH enhancements for cross-carrier scheduling may also include, in a second conceptual example 450, a PDCCH of a Pcell 454 (or a PScell 454/Scell 452) joint scheduling 462 a PDSCH 464 on multiple cells using a single DCI 460. Based on the second conceptual example 450, a number of cells being scheduled at once may be limited to two, and an increase in DCI size may be minimized and/or limited. In view of the PDCCH enhancements, a total PDCCH blind decoding budget should not change. These enhancements may not be specific to DSS and may be generally applicable to cross-carrier scheduling in carrier aggregation.

In an aspect, a Pcell/PScell may be a DSS-carrier using subcarrier spacing (SCS) of, for example, 15 kilo Hertz (kHz), while an Scell may be a non-DSS-carrier using SCS of, for example, 15 kHz or 30 kHz. In another aspect, the Pcell/PScell may have UL resources, while the Scell may not have UL resources (e.g., DL-only carrier aggregation (CA)). In an aspect, the Scell (e.g., non-DSS carrier) can be a NR—unlicensed spectrum (NR-U) carrier.

In an aspect, the following scheduling combinations may be allowed/not allowed when cross-carrier scheduling from an. Scell to a Pcell/PScell is configured: (a) self-scheduling on the Pcell/PScell may be allowed, (b) cross-carrier scheduling from the Pcell/PScell to another Scell may not be allowed, (c) self-scheduling on the Scell used for scheduling the Pcell/PScell may be allowed, (d) cross-carrier scheduling from the Scell used for scheduling the Pcell/PScell to another serving cell may be allowed, and (e) cross-carrier scheduling from another serving cell to the Scell used for scheduling the Pcell/PScell may not be allowed. In another aspect, configuring two or more Scells to schedule the Pcell/PScell may not be allowed.

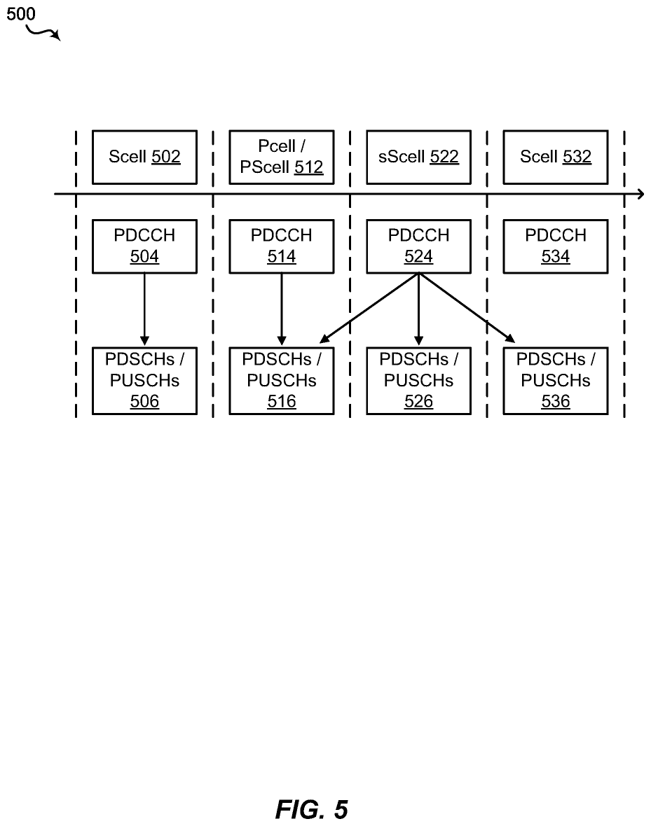

Referring to FIG. 5, a conceptual example of scheduling techniques 500 for Scells and Pcells/PScells based on the above-described configurations are provided. In an aspect, an Scell 502 may perform self-scheduling of PDSCHs/PUSCHs 506 via a PDCCH 504. In an example, the Scell 502 may not participate in this example of cross-carrier scheduling. In an example, a Pcell/PScell 512 may perform self-scheduling of PDSCHs/PUSCHs 516 via a PDCCH 514, and a scheduling Scell 522 may perform self-scheduling of PDSCHs/PUSCHs 526 via a PDCCH 524. The Scell 532 may not perform self-scheduling of PDSCHs/PUSCHs 536 via a PDCCH 534. Instead, the scheduling Scell 522 may perform scheduling of PDSCHs/PUSCHs 516 of the Pcell/PScell 512 and the PDSCHs/PUSCHs 536 of the Scell 532, via the PDCCH 524. Thus, the scheduling Scell 522 may perform cross-carrier scheduling of multiple cells.

For NR, simultaneous reception of multiple PDSCHs on the same serving cell (partially or fully overlapped in time) and out-of-order scheduling for PDSCH/PUSCH may not be supported except for multiple transmission and reception points (multi-TRP) operations.

Simultaneous scheduling, for purposes of this disclosure, may refer to the case where for any two hybrid automatic repeat request (HARQ) process identifications (IDs) in a given scheduled cell, a UE 110 may be scheduled to start receiving a first PDSCH starting in symbol j by a PDCCH ending in symbol i, and the UE 110 may not be expected to be scheduled to receive a PDSCH starting earlier than the end of the first PDSCH with a PDCCH that ends later than symbol i.

Out-of-order scheduling, for purposes of this disclosure, may refer to the case where for any two HARQ process IDs in a given scheduled cell, a UE 110 is scheduled to receive a first PDSCH starting in symbol j by a PDCCH ending in symbol i, and the UE 110 is also scheduled to receive a second PDSCH starting earlier than the end of the first PDSCH with a PDCCH that ends later than symbol i.

Alternatively, out-of-order scheduling may refer to the case where for any two HARQ process IDs in a given scheduled cell, a UE 110 is scheduled to transmit a first PUSCH starting in symbol j by a PDCCH ending in symbol i, and the UE 110 is also scheduled to transmit a second PUSCH starting earlier than the end of the first PUSCH with a PDCCH that ends later than symbol i.

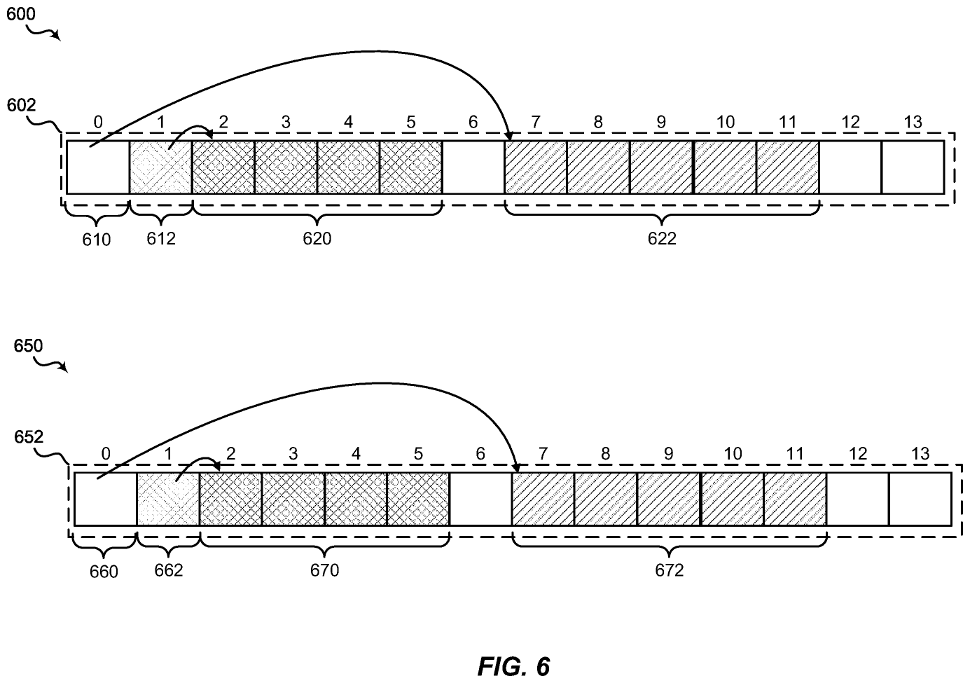

Referring to FIG. 6, a conceptual diagram 600 of simultaneous reception and out-of-order scheduling for single serving cell, is provided. In this example, a serving cell 602 may include a first PDCCH 610 that attempts to schedule a second PDSCH 622 and a second PDCCH 612 that attempt to schedule a first PDSCH 620 on the serving cell 602. However, based on conventional techniques, the simultaneous reception and out-of-order scheduling on the same serving cell may not be allowed.

In an aspect, simultaneous reception of multiple PDSCHs on the same serving cell and out-of-order scheduling for PDSCH/PUSCH may be supported for multi-TRP. For example, a higher-layer parameter including CORESET pool index (or CORESETPoolIndex) (e.g., 0 or 1) may be configured per CORESET for PDCCH. CORESETs configured with different values of the CORESET pool index on the same serving cell can be non quasi-colocated (QCLed), implying that they can be transmitted from different TRPs or panels whose propagation channel profiles (e.g., Doppler shift. Doppler spread, average delay, delay spread, and spatial Rx parameter) that are not the same. Two PDSCHs/PUSCHs scheduled by PDCCHs associated with the CORESETs having different values of the CORESET pool index may be considered as transmitted from different TRPs and hence, simultaneous reception of the PDSCHs may be supported on the same serving cell scheduled by PDCCHs associated with CORESETs with different CORESET pool index values.

Out-of-order transmission/reception of PUSCHs/PDSCHs may be supported on the same serving cell scheduled by PDCCHs associated with CORESETs with different CORESET pool index values.

Referring back to FIG. 6, a conceptual diagram 650 of simultaneous reception and out-of-order scheduling for multi-TRP, is provided. In this example, a serving cell 652 may include a first PDCCH 660 that attempts to schedule a second PDSCH 672 and a second PDCCH 662 that attempt to schedule a first PDSCH 670 on the serving cell 602. In this example, the first PDCCH 660 may correspond to a CORESET with a CORESET pool index of “0,” and the second PDCCH 662 may correspond to a CORESET with a CORESET pool index of “1.” Because the CORESETs have different CORESET pool index values, the simultaneous reception and out-of-order scheduling on the same serving cell may be allowed.

In an aspect, if a UE 110 is configured by a higher layer parameter (e.g., PDCCH-Config) that contains two different values of a CORESET pool index in a control resource set (or ControlResourceSet), the UE 110 may expect to receive multiple PDCCHs scheduling fully/partially/non-overlapped PDSCHs in a time and frequency domain. In this example, the UE 110 may expect the reception of full/partially-overlapped PDSCHs in time only when PDCCHs that schedule two PDSCHs are associated to different control resource sets having different values of the CORESET pool index.

In an aspect, for a control resource set without a CORESET pool index, the UE 110 may assume that the control resource set is assigned with a CORESET pool index of “0.” When the UE 110 is scheduled with full/partially/non-overlapped PDSCHs in time and frequency domain, the full scheduling information for receiving a PDSCH is indicated and carried only by the corresponding PDCCH, the UE 110 may be expected to be scheduled with the same active bandwidth part (BWP) and the same SCS. When the UE 110 is scheduled with full/partially-overlapped PDSCHs in time and frequency domain, the UE 110 can be scheduled with, for example, at most two codewords simultaneously. When PDCCHs that schedule two PDSCHs are associated to different control resource sets having different values of CORESET pool index, the following two operations may be allowed.

In a first operation, for any two HARQ process IDs in a given scheduled cell, if the UE 110 is scheduled to start receiving a first PDSCH starting in symbol j by a PDCCH associated with a value of CORESET pool index ending in symbol i, the UE 110 may be scheduled to receive a PDSCH starting earlier than the end of the first PDSCH with a PDCCH associated with a different value of CORESET pool index that ends later than symbol 1.

In a second operation, in a given scheduled cell, the UE 110 may receive a first PDSCH in slot i, with the corresponding HARQ—acknowledgement (HARQ-ACK) assigned to be transmitted in slot j, and a second PDSCH associated with a value of CORESET pool index different from that of the first PDSCH starting later than the first PDSCH with its corresponding HARQ-ACK assigned to be transmitted in a slot before slot j.

In some examples, there may be the case where a PDCCH detected on the Pcell/PScell and another PDCCH detected on the scheduling Scell (also referred to as an sScell herein) schedules PDSCHs or PUSCHs on the Pcell/PScell. Conventionally, simultaneous PDSCHs and/or out-of-order scheduling for PDSCHs/PUSCHs is/are not allowed.

According to the present disclosure, a first technique may be used for a shared CORESET-pool configuration across two cells. In an aspect, the network may configure up to two values of the CORESETPoolIndex for the CORESETs on the Pcell/PScell and up to two values of CORESETPoolIndex for the CORESETs on the scheduling SCell. For example, a CORESETPoolIndex may include {0, 1, 2, 3}.

In a first example of this first technique, if the values of the CORESETPoolIndex are different between a CORESET on the Pcell/PScell and a CORESET on the scheduling SCell, this may imply the PDCCHs detected on the CORESETs are transmitted from different TRPs, and for this case, simultaneous PDSCHs and/or out-of-order PDSCHs/PUSCHs may be allowed. Thus, the UE 110 may allow simultaneous PDSCHs and/out-of-order PDSCHs/PUSCHs.

In a second example of this first technique, if the value of the CORESETPoolIndex is the same for a CORESET on the Pcell/PScell and for a CORESET on the scheduling SCell, this may imply the PDCCHs detected on the CORESETs are transmitted from the same TRP, and, for this case, simultaneous PDSCHs and/or out-of-order PDSCHs/PUSCHs on the Pcell/PScell may not be allowed. Thus, the UE may not allow simultaneous PDSCHs and/out-of-order PDSCHs/PUSCHs.

In a third example of this first technique, even if the value of the CORESETPoolIndex is the same for a CORESET on the Pcell/PScell and for a CORESET on the scheduling Scell, if the scheduled cells are also different (e.g., the CORESET on the Pcell/PScell is for scheduling data on the Pcell/PScell and the CORESET on the scheduling Scell is for scheduling data on the scheduling Scell), simultaneous PDSCHs and out-of-order PDSCHs/PUSCHs on different scheduled cells may be allowed.

In an aspect, a CORESETPoolIndex equal to 0 for all the CORESETs across the two cells may be equivalent to the case without multi-TRPS. In another aspect, for each cell, the number of values of CORESETPoolIndex may not be more than two.

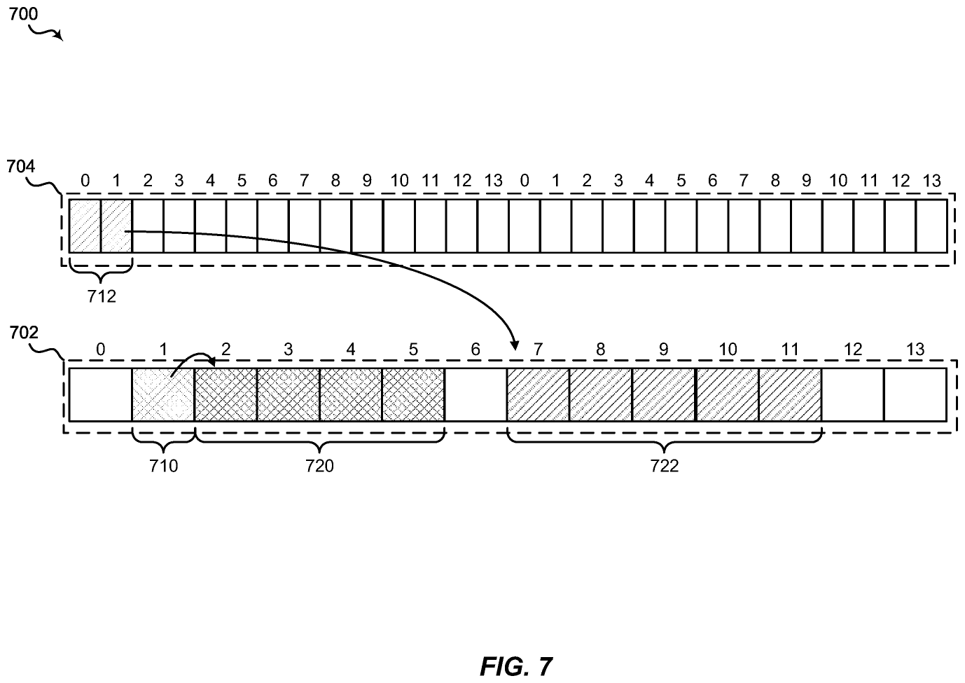

Referring to FIG. 7, an example of cross-carrier scheduling 700 is provided. In an example, a Pcell/PScell 702 may be a first carrier at a low band (e.g., 15 kilo Hertz (kHz)). The Pcell/PScell 702 may be a DSS carrier and/or used for coverage of NR or LTE data. In this example, a scheduling Scell 704 may be a second carrier at a mid-band or high band (e.g., 30 kHz). The scheduling Scell 704 may be a non-DSS carrier and/or does not support NR or LTE. The Pcell/PScell 704 may include a first PDCCH 710 on the Pcell/PScell 704 that may attempt to schedule a PDSCH/PUSCH 720 on the Pcell/PScell 704. The scheduling Scell 704 may include a second PDCCH 712 on the scheduling Scell 702 that may attempt to schedule a PDSCH/PUSCH 722 on the Pcell/PScell 704. Accordingly, due to the cross-carrier scheduling of the scheduling Scell 704, simultaneous scheduling and/or out-of-order scheduling, as illustrated by FIG. 7, may be attempted.

Conventionally, simultaneous scheduling and/or out-of-order scheduling of the PDSCH/PUSCH 720 and the PDSCH/PUSCH 722 would not be allowed. However, techniques provided by the present disclosure address this situation.

In these techniques, a shared control resource set (e.g., CORESET) may be pooled and configured across two cells (e.g., Pcell/PScell and sScell). In an example, the control resource set may refer to a set of physical resources within a specific area of a DL resource grid used to carry PDCCHs (e.g., DCIs). The control resource set may use an index (e.g., CORESETPoolIndex) to identify whether the PDCCHs are from the same or different TRPs. In these techniques, a network (e.g., base station 105) may configure up to two values of indexes for the control resource set on the Pcell/PScell and up to two values on the index for the control resource set on the scheduling Scell.

In a first technique, values of the index may be {0, 1, 2, 3}, where each value may correlate to a different TRP. In a first example of this first technique, if a value (e.g., value=1) of an index corresponding to the first PDCCH 710 on the control resource set of the Pcell/PScell 702 is different from a value (e.g., value=0) of an index on the control resource set of the second PDCCH 712 of the sScell 704, this may imply the first PDCCH 710 and the second PDCCH 712 detected on the corresponding control resource sets are transmitted from different TRPs. In this technique, simultaneous PDSCHs and/out-of-order PDSCHs/PUSCHs may be allowed. Thus, the UE 110 may allow simultaneous PDSCHs and/or out-of-order PDSCHs/PUSCHs in the first example.

In a second example of this first technique, if a value (e.g., value=1) of an index corresponding to the first PDCCH 710 on the control resource set of the Pcell/PScell 702 is the same as a value (e.g., value=1) of an index on the control resource set of the second PDCCH 712 of the sScell 704, this may imply the first PDCCH 710 and the second PDCCH 712 detected on the corresponding control resource sets are transmitted from the same TRPs. Thus, the UE 110 may not allow simultaneous PDSCHs and/out-of-order PDSCHs/PUSCHs in this second example.

In a third example of this first technique, even if a value (e.g., value=1) of an index corresponding to the first PDCCH 710 on the control resource set of the Pcell/PScell 702 is the same as a value (e.g., value=1) of an index on the control resource set of the second PDCCH 712 of the sScell 704, if the scheduled cells are also different (e.g., the control resource set on the Pcell/PScell 702 is for scheduling data on the Pcell/PScell 702 and the control resource set on the scheduling Scell 704 is for scheduling data on the scheduling Scell 704), simultaneous PDSCHs and out-of-order PDSCHs/PUSCHs on different scheduled cells may be allowed.

In a second technique, shared CORESET-pool configuration across two cells may use a more implicit approach. For example, the network may configure up to two values of CORESETPoolIndex for the CORESETs on the Pcell/PScell and up to two values of CORESETPoolIndex for the CORESETs on the scheduling Scell. The values of CORESETPoolIndex may be unchanged as {0, 1}. If the UE monitors PDCCH candidates associated with a CORESET for cross-carrier scheduling, the CORESETPoolIndex for the CORESET may be interpreted based on the scheduled cell. In a first example, the CORESET with CORESETPoolIndex equal to 1 on the scheduling Scell may have UE specific search space (USS) set(s) monitored for cross-carrier scheduling. Therefore, this CORESET and the CORESET(s) with a CORESETPoolIndex equal to 1 on the Pcell/PScell may be considered to be from the same TRP, simultaneous PDSCHs and/or out-of-order PDSCHs/PUSCHs may NOT be allowed. In other words, the UE does not expect simultaneous PDSCHs and/or out-of-order PDSCHs/PUSCHs.

In another example, a CORESET with CORESETPoolIndex equal to 1 on the scheduling Scell and that with CORESETPoolIndex equal to 0 on the Pcell/PScell are considered to be from different TRPs and hence, simultaneous PDSCHs and/or out-of-order PDSCHs/PUSCHs may be allowed. In other words, the UE may expect simultaneous PDSCHs and/or out-of-order PDSCHs/PUSCHs.

In another example, a CORESET with CORESETPoolIndex equal to 0 on the scheduling Scell and that with CORESETPoolIndex equal to 0 on the Pcell/PScell may not be used for cross-carrier scheduling and therefore there may not be a restriction on simultaneous PDSCHs and/or out-of-order PDSCHs/PUSCHs on different cells.

Alternatively, between the Pcell/PScell and the scheduling Scell, CORESETs with the same value of CORESETPoolIndex are considered to be from the same TRP and hence, simultaneous PDSCHs and out-of-order PDSCHs/PUSCHs may not be allowed, regardless of which cell the CORESETs are configured. Accordingly, a CORESET with CORESETPoolIndex equal to 0 for self-scheduling on the sSCell and a CORESET with CORESETPoolIndex equal to 0 for self-scheduling on the PCel/PSCell are considered to be from the same TRP. Simultaneous and Out-of-order may not be allowed.

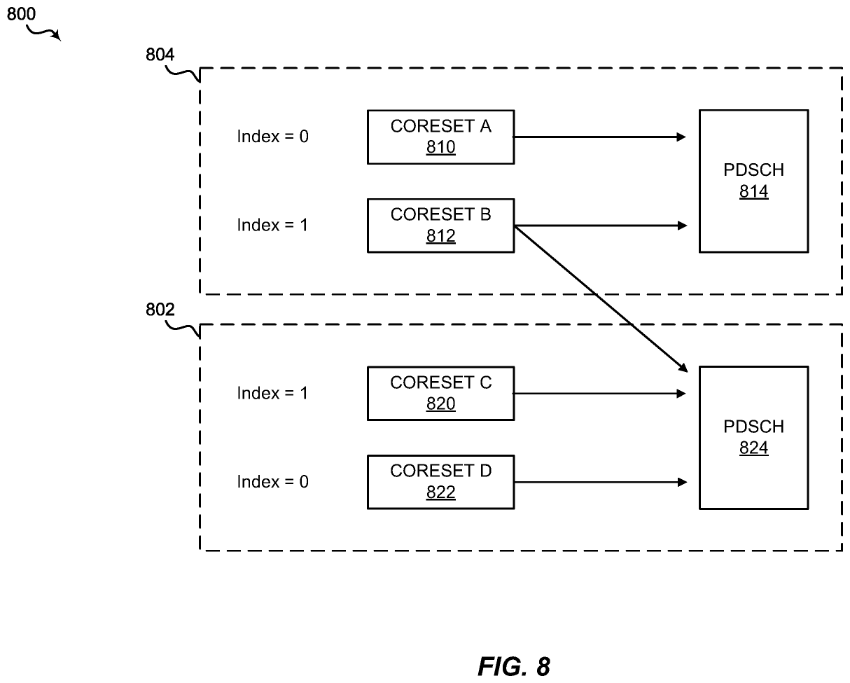

FIG. 8 illustrates a conceptual example of a second technique 800 for cross-carrier scheduling. In the second technique 800, an implicit approach may be used for shared control resource set-pool configurations across two cells. In this technique, the values of the index may be unchanged as {0, 1}. If the UE 110 monitors PDCCH candidates associated with the control resource set for cross-carrier scheduling, the index for the control resource set may be interpreted based on the scheduled cell.

In a first example of the second technique 800, a control resource set B 812 on a scheduling Scell 804 may have an index value (e.g., value=1) indicating that UE specific search space (USS) set(s) are monitored for cross-carrier scheduling. Therefore, the control resource set B 812 and any control resource sets (e.g., CORESET C 820) with a same index value (e.g., value=1) on the Pcell/PScell 802 may be considered to be from the same TRP and bandwidth PDCCHs associated with the control resource set B 812, therefore simultaneous PDSCHs and/or out-of-order PDSCHs/PUSCHs may not be allowed. In other words, the UE 110 does not expect simultaneous PDSCHs 814 or PDSCHs 824 and/or out-of-order PDSCHs 814 or PDSCHs 824 (or PUSCHs).

In a second example of the second technique 800, a control resource set B 812 with an index value (e.g., value=1) on the scheduling Scell 804 having a different index value (e.g., value=0) of a control resource set D 822 on the Pcell/PScell 802 are considered to be from different TRPs and hence, simultaneous PDSCHs and/or out-of-order PDSCHs/PUSCHs may be allowed. In other words, the UE 110 may expect simultaneous PDSCHs 814 or PDSCHs 824 and/or out-of-order PDSCHs 814 or PDSCHs 824 (or PUSCHs).

In another example, a control resource set A 810 with an index value (e.g., value=0) on the scheduling Scell 804 having a same index value (e.g, value=0) of a control resource set D 822 on the Pcell/PScell 802 may not be used for cross-carrier scheduling and therefore hence there may not be a restriction on simultaneous PDSCHs and/or out-of-order PDSCHs/PUSCHs on different cells. In other words, the UE 110 may expect simultaneous PDSCHs 814 or PDSCHs 824 and/or out-of-order PDSCHs 814 or PDSCHs 824 (or PUSCHs).

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

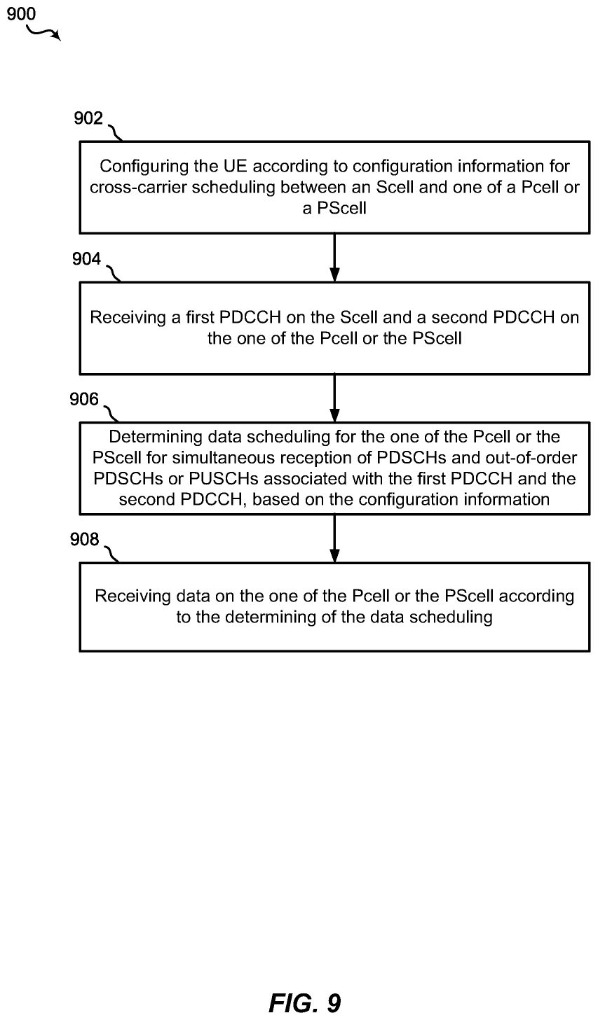

Referring to FIG. 9, an example of a method 900 for cross-carrier scheduling may be performed by the cross-carrier schedule determining component 142, the modem 140, the transceiver 202, the processor 212, the memory 216, and or any other component/subcomponent of the UE 110 of the wireless communication network 100.

At block 902, the method 900 may include configuring the UE according to configuration information for cross-carrier scheduling between an Scell and one of a Pcell or a PScell. For example, the cross-carrier schedule determining component 142, the modem 140, the transceiver 202, the processor 212, and/or the memory 216 of the UE 110, and/or one or more additional components/subcomponents of the UE 110 may be configured to or may comprise means for configuring the UE according to configuration information for cross-carrier scheduling between an Scell and one of a Pcell or a PScell.

For example, the configuring of the UE 110 at the block 902 may include configuring the cross-carrier schedule determining component 142, the modem 140, the the processor 212, and/or the memory 216 of the UE 110, according to configuration information including instructions for interpreting indexes of control resource sets to determine whether simultaneous PDCCHs and/or out-of-order PDCCHs are allowed or not allowed. In an example, the configuration information may be received from the base station 105.

At block 904, the method 900 may include receiving a first PDCCH on the Scell and a second PDCCH on the one of the Pcell or the PScell. For example, the cross-carrier schedule determining component 142, the modem 140, the transceiver 202, the processor 212, and/or the memory 216 of the UE 110, and/or one or more additional components/subcomponents of the UE 110 may be configured to or may comprise means for receiving a first PDCCH on the Scell and a second PDCCH on the one of the Pcell or the PScell.

For example, the receiving the first PDCCH on the Scell and the second PDCCH on the one of the Pcell or the PScell at block 904 may include receiving by the cross-carrier schedule determining component 142, the modem 140, the processor 212, the transceiver 202, and/or the memory 216 of the UE 110 the PDCCH 712 on the Scell 704 and the PDCCH 710 on the one of the Pcell 702 or the PScell 702.

In an aspect, the configuration information includes one or more cross-carrier scheduling rules based on indexes of core resource sets of the Scell and the one of the Pcell or the PScell.

At block 906, the method 900 may include determining data scheduling for the one of the Pcell or the PScell for simultaneous reception of PDSCHs and out-of-order PDSCHs or PUSCHs associated with the first PDCCH and the second PDCCH, based on the configuration information. For example, the cross-carrier schedule determining component 142, the modem 140, the processor 212, and/or the memory 216 of the UE 110, and/or one or more additional components/subcomponents of the UE 110 may be configured to or may comprise means for determining data scheduling for the one of the Pcell or the PScell for simultaneous reception of PDSCHs and out-of-order PDSCHs or PUSCHs associated with the first PDCCH and the second PDCCH, based on the configuration information.

For example, the determining the data scheduling may include determining by the cross-carrier schedule determining component 142, the modem 140, the processor 212, and/or the memory 216 of the UE 110 the data scheduling for the one of the Pcell 702 or the PScell 702 for simultaneous reception of PDSCHs (e.g., PDSCHs 720, 722) and out-of-order PDSCHs (e.g., PDSCHs 720, 722) or PUSCHs associated with the PDCCH 712 and the PDCCH 710, based on the configuration information.

In an aspect, the data scheduling may be determined by determining a first index value corresponding to a first control resource set of the Scell is different from a second index value corresponding to a second control resource set of the one of the Pcell or the PScell, and determining one or more of the simultaneous reception of PDSCHs or the out-of-order PDSCHs or PUSCHs are allowed, in response to the determining the first index value is different from the second index value.

In another aspect, the data scheduling may be determined by determining a first index value corresponding to a first control resource set of the Scell is equal to a second index value corresponding to a second control resource set of the one of the Pcell or the PScell, and determining one or more of the simultaneous reception of PDSCHs or the out-of-order PDSCHs or PUSCHs are not allowed, in response to the determining the first index value is equal to as the second index value.

In another aspect, the data scheduling may be determined by determining a first index value corresponding to a first control resource set of the Scell is equal to a second index value corresponding to a second control resource set of the one of the Pcell or the PScell, determining a first scheduling cell for the first PDCCH is different from a second scheduling cell for the second PDCCH, in response to the determining the first index value is equal to the second index value, and determining one or more of the simultaneous reception of PDSCHs or the out-of-order PDSCHs or PUSCHs are allowed on the first scheduling cell and the second scheduling cell, in response to the determining the first scheduling cell is different from the second scheduling cell.

In another aspect, the data scheduling may be determined by determining a first index value corresponding to a first control resource set of the Scell is equal to a second index value corresponding to a second control resource set of the one of the Pcell or the PScell, wherein the first index value and the second index value correspond to a UE specific search space set, and determining one or more of the simultaneous reception of PDSCHs or the out-of-order PDSCHs or PUSCHs are not allowed, in response to the determining the first index value is equal to the second index value.

In another aspect, the data scheduling may be determined by determining a first index value corresponding to a first control resource set of the Scell is different from a second index value corresponding to a second control resource set of the one of the Pcell or the PScell, and determining one or more of the simultaneous reception of PDSCHs or the out-of-order PDSCHs or PUSCHs are allowed, in response to the determining the first index value is different from the second index value.

In another aspect, the data scheduling may be determined by determining a first index value corresponding to a first control resource set of the Scell is equal to a second index value corresponding to a second control resource set of the one of the Pcell or the PScell, wherein the first index value and the second index value correspond to cells not used for cross-carrier scheduling, and determining one or more of the simultaneous reception of PDSCHs or the out-of-order PDSCHs or PUSCHs are allowed, in response to the determining the first index value is equal to the second index value.

At block 908, the method 900 may include receiving data on the one of the Pcell or the PScell according to the determining of the data scheduling. For example, the cross-carrier schedule determining component 142, the modem 140, the transceiver 202, the processor 212, and/or the memory 216 of the UE 110, and/or one or more additional components/subcomponents of the UE 110 may be configured to or may comprise means for receiving data on the one of the Pcell or the PScell according to the determining of the data scheduling.

For example, the receiving of the data at block 908 may include receiving by the cross-carrier schedule determining component 142, the modem 140, the transceiver 202, the processor 212, and/or the memory 216 of the UE 110, via the antenna 265, the RF front end 288, and/or the transceiver 202, to the UE 110, the data on the one of the Pcell 702 or the PScell 702 according to the determining of the data scheduling.

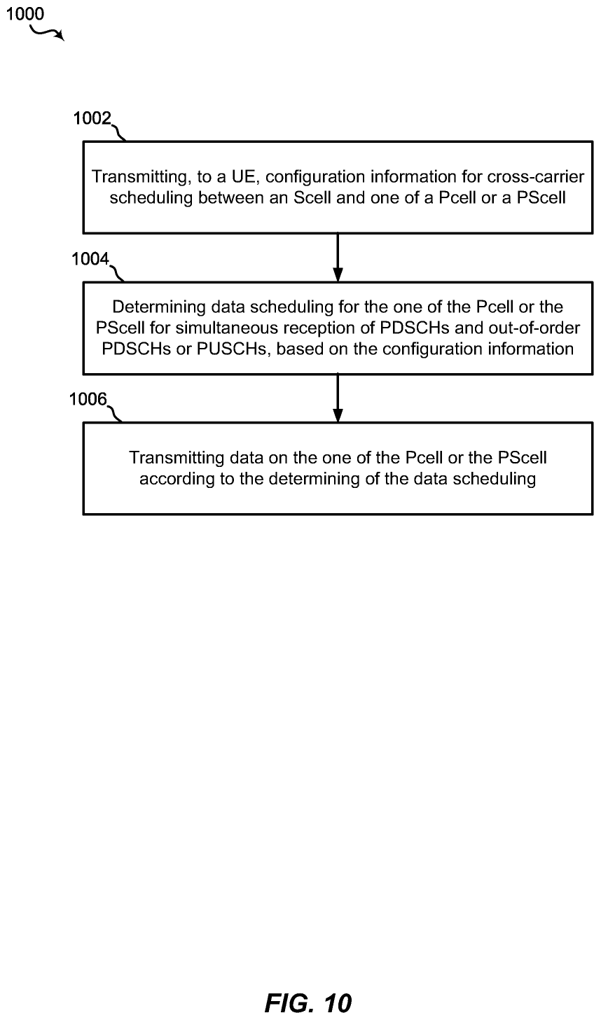

Referring to FIG. 10, an example of a method 1000 for cross-carrier scheduling may be performed by the cross-carrier scheduling component 146, the modem 144, the transceiver 302, the processor 312, the memory 316, and or any other component/subcomponent of the base station 105 of the wireless communication network 100.

At block 1002, the method 1000 may include transmitting, to a UE, configuration information for cross-carrier scheduling between an Scell and one of a Pcell or a PScell. For example, the cross-carrier scheduling component 146, the modem 144, the transceiver 302, the processor 312, and/or the memory 316 of the base station 105, and/or one or more additional components/subcomponents of the base station 105 may be configured to or may comprise means for transmitting, to a UE, configuration information for cross-carrier scheduling between an Scell and one of a Pcell or a PScell.

For example, the transmitting of the configuration information at the block 1002 may include transmitting by the cross-carrier scheduling component 146, the modem 144, the transceiver 302, the processor 312, and/or the memory 316 of the base station 105, via the antenna 365, the RF front end 388, and/or the transceiver 202, to the UE 110, configuration information for cross-carrier scheduling between the Scell 704 and one of a Pcell 702 or a PScell 704.

In an aspect, the configuration information includes one or more cross-carrier scheduling rules based on indexes of core resource sets of the Scell and the one of the Pcell or the PScell.

In another aspect, the configuration information includes instructions for the UE to allow one or more of the simultaneous reception of PDSCHs or the out-of-order PDSCHs or PUSCHs in response to the UE determining a first index value corresponding to a first control resource set of the Scell being different from a second index value corresponding to a second control resource set of the one of the Pcell or the PScell.

In another aspect, the configuration information includes instructions for the UE to not allow one or more of the simultaneous reception of PDSCHs or the out-of-order PDSCHs or PUSCHs in response to the UE determining a first index value corresponding to a first control resource set of the Scell is equal to a second index value corresponding to a second control resource set of the one of the Pcell or the PScell.

In another aspect, the configuration information includes instructions for the UE to allow one or more of the simultaneous reception of PDSCHs or the out-of-order PDSCHs or PUSCHs in response to the UE determining a first index value corresponding to a first control resource set of the Scell is equal to a second index value corresponding to a second control resource set of the one of the Pcell or the PScell and the UE determining a first scheduling cell for the first PDCCH is different from a second scheduling cell for the second PDCCH.

In another aspect, the configuration information includes instructions for the UE to not allow one or more of the simultaneous reception of PDSCHs or the out-of-order PDSCHs or PUSCHs in response to the UE determining a first index value corresponding to a first control resource set of the Scell is equal to a second index value corresponding to a second control resource set of the one of the Pcell or the PScell, wherein the first index value and the second index value correspond to a UE specific search space set.

In another aspect, the configuration information includes instructions for the UE to allow one or more of the simultaneous reception of PDSCHs or the out-of-order PDSCHs or PUSCHs in response to the UE determining a first index value corresponding to a first control resource set of the Scell is different from a second index value corresponding to a second control resource set of the one of the Pcell or the PScell.

In another aspect, the configuration information includes instructions for the UE to allow one or more of the simultaneous reception of PDSCHs or the out-of-order PDSCHs or PUSCHs in response to the UE determining a first index value corresponding to a first control resource set of the Scell is equal to a second index value corresponding to a second control resource set of the one of the Pcell or the PScell, wherein the first index value and the second index value correspond to cells not used for cross-carrier scheduling.

At block 1004, the method 1000 may include determining data scheduling for the one of the Pcell or the PScell for simultaneous reception of PDSCHs and out-of-order PDSCHs or PUSCHs, based on the configuration information. For example, the cross-carrier scheduling component 146, the modem 144, the transceiver 302, the processor 312, and/or the memory 316 of the base station 105, and/or one or more additional components/subcomponents of the base station 105 may be configured to or may comprise means for determining data scheduling for the one of the Pcell 702 or the PScell 702 for simultaneous reception of PDSCHs 720 and 722 and out-of-order PDSCHs 720 and 722 or PUSCHs, based on the configuration information.

For example, the determining at block 1004 may include determining by the cross-carrier scheduling component 146, the modem 144, the processor 312, and/or the memory 316 of the base station 105, data scheduling for the one of the Pcell 702 or the PScell 702 for simultaneous reception of PDSCHs 720 and 722 and out-of-order PDSCHs 720 and 722 or PUSCHs, based on the configuration information.

At block 1006, the method 1000 may include transmitting data on the one of the Pcell or the PScell according to the determining of the data scheduling. For example, the cross-carrier scheduling component 146, the modem 144, the transceiver 302, the processor 312, and/or the memory 316 of the base station 105, and/or one or more additional components/subcomponents of the base station 105 may be configured to or may comprise means for transmitting data on the one of the Pcell or the PScell according to the determining of the data scheduling.

For example, the transmitting of the data at the block 1006 may include transmitting by the cross-carrier scheduling component 146, the modem 144, the transceiver 302, the processor 312, and/or the memory 316 of the base station 105, via the antenna 365, the RF front end 388, and/or the transceiver 202 data on the one of the Pcell 702 or the PScell 702 according to the determining of the data scheduling.

### ADDITIONAL IMPLEMENTATIONS

An example method of wireless communication by a UE, comprising: configuring the UE according to configuration information for cross-carrier scheduling between an Scell and one of a Pcell or a PScell; receiving a first PDCCH on the Scell and a second PDCCH on the one of the Pcell or the PScell; scheduling data for the one of the Pcell or the PScell for simultaneous reception of PDSCHs and out-of-order PDSCHs or PUSCHs associated with the first PDCCH and the second PDCCH, based on the configuration information; and receiving data on the one of the Pcell or the PScell according to the scheduling of the data.

The above example method, wherein the configuration information includes one or more cross-carrier scheduling rules based on indexes of core resource sets of the Scell and the one of the Pcell or the PScell.

One or more of the above example methods, wherein the scheduling of the data comprises: determining a first index value corresponding to a first control resource set of the Scell is different from a second index value corresponding to a second control resource set of the one of the Pcell or the PScell; and determining one or more of the simultaneous reception of PDSCHs or the out-of-order PDSCHs or PUSCHs are allowed, in response to the determining the first index value is different from the second index value.

One or more of the above example methods, wherein the scheduling of the data comprises: determining a first index value corresponding to a first control resource set of the Scell is equal to a second index value corresponding to a second control resource set of the one of the Pcell or the PScell; and determining one or more of the simultaneous reception of PDSCHs or the out-of-order PDSCHs or PUSCHs are not allowed, in response to the determining the first index value is equal to as the second index value.

One or more of the above example methods, wherein the scheduling of the data comprises: determining a first index value corresponding to a first control resource set of the Scell is equal to a second index value corresponding to a second control resource set of the one of the Pcell or the PScell; determining a first scheduling cell for the first PDCCH is different from a second scheduling cell for the second PDCCH, in response to the determining the first index value is equal to the second index value; and determining one or more of the simultaneous reception of PDSCHs or the out-of-order PDSCHs or PUSCHs are allowed on the first scheduling cell and the second scheduling cell, in response to the determining the first scheduling cell is different from the second scheduling cell.

One or more of the above example methods, wherein the scheduling of the data comprises: determining a first index value corresponding to a first control resource set of the Scell is equal to a second index value corresponding to a second control resource set of the one of the Pcell or the PScell, wherein the first index value and the second index value correspond to a UE specific search space set; and determining one or more of the simultaneous reception of PDSCHs or the out-of-order PDSCHs or PUSCHs are not allowed, in response to the determining the first index value is equal to the second index value.

One or more of the above example methods, wherein the scheduling of the data comprises: determining a first index value corresponding to a first control resource set of the Scell is different from a second index value corresponding to a second control resource set of the one of the Pcell or the PScell; and determining one or more of the simultaneous reception of PDSCHs or the out-of-order PDSCHs or PUSCHs are allowed, in response to the determining the first index value is different from the second index value.

One or more of the above example methods, wherein the scheduling of the data comprises: determining a first index value corresponding to a first control resource set of the Scell is equal to a second index value corresponding to a second control resource set of the one of the Pcell or the PScell, wherein the first index value and the second index value correspond to cells not used for cross-carrier scheduling; and determining one or more of the simultaneous reception of PDSCHs or the out-of-order PDSCHs or PUSCHs are allowed, in response to the determining the first index value is equal to the second index value.

One or more of the above example methods, further comprising: receiving the configuration information from a base station.

An example UE, comprising: a memory storing instructions; and one or more processors coupled with the memory and configured to: configure the UE according to configuration information for cross-carrier scheduling between an Scell and one of a Pcell or a PScell; receive a first PDCCH on the Scell and a second PDCCH on the one of the Pcell or the PScell; schedule data for the one of the Pcell or the PScell for simultaneous reception of PDSCHs and out-of-order PDSCHs or PUSCHs associated with the first PDCCH and the second PDCCH, based on the configuration information; and receive data on the one of the Pcell or the PScell according to the scheduling of the data.

The above-example UE, wherein the configuration information includes one or more cross-carrier scheduling rules based on indexes of core resource sets of the Scell and the one of the Pcell or the PScell.

One or more of the above-example UEs, wherein the one or more processors is further configured to: determine a first index value corresponding to a first control resource set of the Scell is different from a second index value corresponding to a second control resource set of the one of the Pcell or the PScell; and determine one or more of the simultaneous reception of PDSCHs or the out-of-order PDSCHs or PUSCHs are allowed, in response to the first index value being determined to be different from the second index value.

One or more of the above-example UEs, wherein the one or more processors is further configured to: determine a first index value corresponding to a first control resource set of the Scell is equal to a second index value corresponding to a second control resource set of the one of the Pcell or the PScell; and determine one or more of the simultaneous reception of PDSCHs or the out-of-order PDSCHs or PUSCHs are not allowed, in response to the first index value being determined to be equal to the second index value.

One or more of the above-example UEs, wherein the one or more processors is further configured to: determine a first index value corresponding to a first control resource set of the Scell is different from a second index value corresponding to a second control resource set of the one of the Pcell or the PScell; and determine one or more of the simultaneous reception of PDSCHs or the out-of-order PDSCHs or PUSCHs are allowed, in response to the first index value being determined to be different from the second index value.

One or more of the above-example UEs, wherein the one or more processors is further configured to: determine a first index value corresponding to a first control resource set of the Scell is equal to a second index value corresponding to a second control resource set of the one of the Pcell or the PScell; and determine one or more of the simultaneous reception of PDSCHs or the out-of-order PDSCHs or PUSCHs are not allowed, in response to the first index value being determined to be equal to the second index value.

One or more of the above-example UEs, wherein the one or more processors is further configured to: determine a first index value corresponding to a first control resource set of the Scell is equal to a second index value corresponding to a second control resource set of the one of the Pcell or the PScell; determine a first scheduling cell for the first PDCCH is different from a second scheduling cell for the second PDCCH, in response to the first index value being determined to be equal to the second index value; and determine one or more of the simultaneous reception of PDSCHs or the out-of-order PDSCHs or PUSCHs are allowed on the first scheduling cell and the second scheduling cell, in response to the first scheduling cell being determined to be different from the second scheduling cell.

One or more of the above-example UEs, wherein the one or more processors is further configured to: determine a first index value corresponding to a first control resource set of the Scell is equal to a second index value corresponding to a second control resource set of the one of the Pcell or the PScell, wherein the first index value and the second index value correspond to a UE specific search space set; and determine one or more of the simultaneous reception of PDSCHs or the out-of-order PDSCHs or PUSCHs are not allowed, in response to the first index value being determined to be equal to the second index value.

One or more of the above-example UEs, wherein the one or more processors is further configured to: determine a first index value corresponding to a first control resource set of the Scell is different from a second index value corresponding to a second control resource set of the one of the Pcell or the PScell; and determine one or more of the simultaneous reception of PDSCHs or the out-of-order PDSCHs or PUSCHs are allowed, in response to the first index value being determined to be different from the second index value.

One or more of the above-example UEs, wherein the one or more processors is further configured to: determine a first index value corresponding to a first control resource set of the Scell is equal to a second index value corresponding to a second control resource set of the one of the Pcell or the PScell, wherein the first index value and the second index value correspond to cells not used for cross-carrier scheduling; and determine one or more of the simultaneous reception of PDSCHs or the out-of-order PDSCHs or PUSCHs are allowed, in response to the first index value being determined to be equal to the second index value.

One or more of the above-example UEs, wherein the one or more processors is further configured to: receive the configuration information from a base station.

A computer readable medium having instructions stored therein that, when executed by one or more processors, cause the one or more processors to perform any of the one or more above example methods.

An apparatus, comprising: means for performing any of the one or more above example methods.

A second example method of wireless communication by a base station, comprising: transmitting, to a UE, configuration information for cross-carrier scheduling between an Scell and one of a Pcell or a PScell; scheduling data for the one of the Pcell or the PScell for simultaneous reception of PDSCHs and out-of-order PDSCHs or PUSCHs, based on the configuration information; and transmitting data on the one of the Pcell or the PScell according to the scheduling of the data.

The above second example method, wherein the configuration information includes one or more cross-carrier scheduling rules based on indexes of core resource sets of the Scell and the one of the Pcell or the PScell.

One or more of the above second example methods, wherein the configuration information comprises: instructions for the UE to allow one or more of the simultaneous reception of PDSCHs or the out-of-order PDSCHs or PUSCHs in response to the UE determining a first index value corresponding to a first control resource set of the Scell being different from a second index value corresponding to a second control resource set of the one of the Pcell or the PScell.

One or more of the above second example methods, wherein the configuration information comprises: instructions for the UE to not allow one or more of the simultaneous reception of PDSCHs or the out-of-order PDSCHs or PUSCHs in response to the UE determining a first index value corresponding to a first control resource set of the Scell is equal to a second index value corresponding to a second control resource set of the one of the Pcell or the PScell.

One or more of the above second example methods, wherein the configuration information comprises: instructions for the UE to allow one or more of the simultaneous reception of PDSCHs or the out-of-order PDSCHs or PUSCHs in response to the UE determining a first index value corresponding to a first control resource set of the Scell is equal to a second index value corresponding to a second control resource set of the one of the Pcell or the PScell.

One or more of the above second example methods, wherein the configuration information comprises: instructions for the UE to not allow one or more of the simultaneous reception of PDSCHs or the out-of-order PDSCHs or PUSCHs in response to the UE determining a first index value corresponding to a first control resource set of the Scell is equal to a second index value corresponding to a second control resource set of the one of the Pcell or the PScell, wherein the first index value and the second index value correspond to a UE specific search space set.

One or more of the above second example methods, wherein the configuration information comprises: instructions for the UE to allow one or more of the simultaneous reception of PDSCHs or the out-of-order PDSCHs or PUSCHs in response to the UE determining a first index value corresponding to a first control resource set of the Scell is different from a second index value corresponding to a second control resource set of the one of the Pcell or the PScell.

One or more of the above second example methods, wherein the configuration information comprises: instructions for the UE to allow one or more of the simultaneous reception of PDSCHs or the out-of-order PDSCHs or PUSCHs in response to the UE determining a first index value corresponding to a first control resource set of the Scell is equal to a second index value corresponding to a second control resource set of the one of the Pcell or the PScell, wherein the first index value and the second index value correspond to cells not used for cross-carrier scheduling.

An example base station, comprising: a memory storing instructions; and one or more processors coupled with the memory and configured to: transmit, to a UE, configuration information for cross-carrier scheduling between an Scell and one of a Pcell or a PScell; schedule data for the one of the Pcell or the PScell for simultaneous reception of PDSCHs and out-of-order PDSCHs or PUSCHs, based on the configuration information; and transmit data on the one of the Pcell or the PScell according to the scheduling of the data.

The above-example base station, wherein the configuration information includes one or more cross-carrier scheduling rules based on indexes of core resource sets of the Scell and the one of the Pcell or the PScell.

One or more of the above example base stations, wherein the configuration information comprises: instructions for the UE to allow one or more of the simultaneous reception of PDSCHs or the out-of-order PDSCHs or PUSCHs in response to a first index value corresponding to a first control resource set of the Scell being determined by the UE to be different from a second index value corresponding to a second control resource set of the one of the Pcell or the PScell.

One or more of the above example base stations, wherein the configuration information comprises: instructions for the UE to not allow one or more of the simultaneous reception of PDSCHs or the out-of-order PDSCHs or PUSCHs in response to a first index value corresponding to a first control resource set of the Scell being determined by the UE to be equal to a second index value corresponding to a second control resource set of the one of the Pcell or the PScell.

One or more of the above example base stations, wherein the configuration information comprises: instructions for the UE to allow one or more of the simultaneous reception of PDSCHs or the out-of-order PDSCHs or PUSCHs in response to a first index value corresponding to a first control resource set of the Scell being determined to be equal to a second index value corresponding to a second control resource set of the one of the Pcell or the PScell.

One or more of the above example base stations, wherein the configuration information comprises: instructions for the UE to not allow one or more of the simultaneous reception of PDSCHs or the out-of-order PDSCHs or PUSCHs in response to a first index value corresponding to a first control resource set of the Scell being determined to be equal to a second index value corresponding to a second control resource set of the one of the Pcell or the PScell, wherein the first index value and the second index value correspond to a UE specific search space set.

One or more of the above example base stations, wherein the configuration information comprises: instructions for the UE to allow one or more of the simultaneous reception of PDSCHs or the out-of-order PDSCHs or PUSCHs in response to a first index value corresponding to a first control resource set of the Scell being determined to be different from a second index value corresponding to a second control resource set of the one of the Pcell or the PScell.

One or more of the above example base stations, wherein the configuration information comprises: instructions for the UE to allow one or more of the simultaneous reception of PDSCHs or the out-of-order PDSCHs or PUSCHs in response to a first index value corresponding to a first control resource set of the Scell being determined to be equal to a second index value corresponding to a second control resource set of the one of the Pcell or the PScell, wherein the first index value and the second index value correspond to cells not used for cross-carrier scheduling.

A computer readable medium having instructions stored therein that, when executed by one or more processors, cause the one or more processors to perform any of the one or more above second example methods.

An apparatus, comprising: means for performing any of the one or more above second example methods.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of wireless communication by a user equipment (UE), comprising:
configuring the UE according to configuration information for cross-carrier scheduling between a secondary cell (Scell) and one of a primary cell (Pcell) or a primary Scell (PScell);
receiving a first physical downlink control channel (PDCCH) on the Scell and a second PDCCH on the one of the Pcell or the PScell;
scheduling data for the one of the Pcell or the PScell for simultaneous reception of physical downlink scheduling channels (PDSCHs) and out-of-order PDSCHs or PUSCHs associated with the first PDCCH and the second PDCCH, based on the configuration information; and
receiving data on the one of the Pcell or the PScell according to the scheduling of the data.

2. The method of claim 1, wherein the configuration information includes one or more cross-carrier scheduling rules based on indexes of core resource sets of the Scell and the one of the Pcell or the PScell.

3. The method of claim 1, wherein the scheduling of the data comprises:
determining a first index value corresponding to a first control resource set of the Scell is different from a second index value corresponding to a second control resource set of the one of the Pcell or the PScell; and
determining one or more of the simultaneous reception of PDSCHs or the out-of-order PDSCHs or PUSCHs are allowed, in response to the first index value being determined to be different from the second index value.

4. The method of claim 1, wherein the scheduling of the data comprises:
determining a first index value corresponding to a first control resource set of the Scell is equal to a second index value corresponding to a second control resource set of the one of the Pcell or the PScell; and
determining one or more of the simultaneous reception of PDSCHs or the out-of-order PDSCHs or PUSCHs are not allowed, in response to the first index value being determined to be equal to the second index value.

5. The method of claim 1, wherein the scheduling of the data comprises:
determining a first index value corresponding to a first control resource set of the Scell is equal to a second index value corresponding to a second control resource set of the one of the Pcell or the PScell;
determining a first scheduling cell for the first PDCCH is different from a second scheduling cell for the second PDCCH, in response to the first index value being determined to be equal to the second index value; and
determining one or more of the simultaneous reception of PDSCHs or the out-of-order PDSCHs or PUSCHs are allowed on the first scheduling cell and the second scheduling cell, in response to the first scheduling cell being determined to be different from the second scheduling cell.

6. The method of claim 1, wherein the scheduling of the data comprises:
determining a first index value corresponding to a first control resource set of the Scell is equal to a second index value corresponding to a second control resource set of the one of the Pcell or the PScell, wherein the first index value and the second index value correspond to a UE specific search space set; and
determining one or more of the simultaneous reception of PDSCHs or the out-of-order PDSCHs or PUSCHs are not allowed, in response to the first index value being determined to be equal to the second index value.

7. The method of claim 1, wherein the scheduling of the data comprises:
determining a first index value corresponding to a first control resource set of the Scell is different from a second index value corresponding to a second control resource set of the one of the Pcell or the PScell; and
determining one or more of the simultaneous reception of PDSCHs or the out-of-order PDSCHs or PUSCHs are allowed, in response to the first index value being determined to be different from the second index value.

8. The method of claim 1, wherein the scheduling of the data comprises:
determining a first index value corresponding to a first control resource set of the Scell is equal to a second index value corresponding to a second control resource set of the one of the Pcell or the PScell, wherein the first index value and the second index value correspond to cells not used for cross-carrier scheduling; and
determining one or more of the simultaneous reception of PDSCHs or the out-of-order PDSCHs or PUSCHs are allowed, in response to the first index value being determined to be equal to the second index value.

9. The method of claim 1, further comprising:
receiving the configuration information from a base station.

10. A method of wireless communication by a base station, comprising:
transmitting, to a user equipment (UE), configuration information for cross-carrier scheduling between a secondary cell (Scell) and one of a primary cell (Pcell) or a primary Scell (PScell);
scheduling data for the one of the Pcell or the PScell for simultaneous reception of physical downlink scheduling channels (PDSCHs) and out-of-order PDSCHs or PUSCHs, based on the configuration information; and
transmitting data on the one of the Pcell or the PScell according to the scheduling of the data.

11. The method of claim 10, wherein the configuration information includes one or more cross-carrier scheduling rules based on indexes of core resource sets of the Scell and the one of the Pcell or the PScell.

12. The method of claim 10, wherein the configuration information comprises:
instructions for the UE to allow one or more of the simultaneous reception of PDSCHs or the out-of-order PDSCHs or PUSCHs in response to a first index value corresponding to a first control resource set of the Scell being determined by the UE to be different from a second index value corresponding to a second control resource set of the one of the Pcell or the PScell.

13. The method of claim 10, wherein the configuration information comprises:
instructions for the UE to not allow one or more of the simultaneous reception of PDSCHs or the out-of-order PDSCHs or PUSCHs in response to a first index value corresponding to a first control resource set of the Scell being determined by the UE to be equal to a second index value corresponding to a second control resource set of the one of the Pcell or the PScell.

14. The method of claim 10, wherein the configuration information comprises:
instructions for the UE to allow one or more of the simultaneous reception of PDSCHs or the out-of-order PDSCHs or PUSCHs in response to a first index value corresponding to a first control resource set of the Scell being determined to be equal to a second index value corresponding to a second control resource set of the one of the Pcell or the PScell.

15. The method of claim 10, wherein the configuration information comprises:
instructions for the UE to not allow one or more of the simultaneous reception of PDSCHs or the out-of-order PDSCHs or PUSCHs in response to a first index value corresponding to a first control resource set of the Scell being determined to be equal to a second index value corresponding to a second control resource set of the one of the Pcell or the PScell, wherein the first index value and the second index value correspond to a UE specific search space set.

16. The method of claim 10, wherein the configuration information comprises:
instructions for the UE to allow one or more of the simultaneous reception of PDSCHs or the out-of-order PDSCHs or PUSCHs in response to a first index value corresponding to a first control resource set of the Scell being determined to be different from a second index value corresponding to a second control resource set of the one of the Pcell or the PScell.

17. The method of claim 10, wherein the configuration information comprises:
instructions for the UE to allow one or more of the simultaneous reception of PDSCHs or the out-of-order PDSCHs or PUSCHs in response to a first index value corresponding to a first control resource set of the Scell being determined to be equal to a second index value corresponding to a second control resource set of the one of the Pcell or the PScell, wherein the first index value and the second index value correspond to cells not used for cross-carrier scheduling.

18. A user equipment (UE), comprising:
a memory storing instructions; and
one or more processors coupled with the memory and configured to:
configure the UE according to configuration information for cross-carrier scheduling between a secondary cell (Scell) and one of a primary cell (Pcell) or a primary Scell (PScell);
receive a first physical downlink control channel (PDCCH) on the Scell and a second PDCCH on the one of the Pcell or the PScell;
schedule data for the one of the Pcell or the PScell for simultaneous reception of physical downlink scheduling channels (PDSCHs) and out-of-order PDSCHs or PUSCHs associated with the first PDCCH and the second PDCCH, based on the configuration information; and
receive data on the one of the Pcell or the PScell according to the scheduling of the data.

19. The UE of claim 18, wherein the configuration information includes one or more cross-carrier scheduling rules based on indexes of core resource sets of the Scell and the one of the Pcell or the PScell.

20. The UE of claim 18, wherein the one or more processors is further configured to:
determine a first index value corresponding to a first control resource set of the Scell is different from a second index value corresponding to a second control resource set of the one of the Pcell or the PScell; and
determine one or more of the simultaneous reception of PDSCHs or the out-of-order PDSCHs or PUSCHs are allowed, in response to the first index value being determined to be different from the second index value.

21. The UE of claim 18, wherein the one or more processors is further configured to:
determine a first index value corresponding to a first control resource set of the Scell is equal to a second index value corresponding to a second control resource set of the one of the Pcell or the PScell; and
determine one or more of the simultaneous reception of PDSCHs or the out-of-order PDSCHs or PUSCHs are not allowed, in response to the first index value being determined to be equal to the second index value.

22. The UE of claim 18, wherein the one or more processors is further configured to:
determine a first index value corresponding to a first control resource set of the Scell is different from a second index value corresponding to a second control resource set of the one of the Pcell or the PScell; and
determine one or more of the simultaneous reception of PDSCHs or the out-of-order PDSCHs or PUSCHs are allowed, in response to the first index value being determined to be different from the second index value.

23. The UE of claim 18, wherein the one or more processors is further configured to:
determine a first index value corresponding to a first control resource set of the Scell is equal to a second index value corresponding to a second control resource set of the one of the Pcell or the PScell; and
determine one or more of the simultaneous reception of PDSCHs or the out-of-order PDSCHs or PUSCHs are not allowed, in response to the first index value being determined to be equal to the second index value.

24. The UE of claim 18, wherein the one or more processors is further configured to:
determine a first index value corresponding to a first control resource set of the Scell is equal to a second index value corresponding to a second control resource set of the one of the Pcell or the PScell;
determine a first scheduling cell for the first PDCCH is different from a second scheduling cell for the second PDCCH, in response to the first index value being determined to be equal to the second index value; and
determine one or more of the simultaneous reception of PDSCHs or the out-of-order PDSCHs or PUSCHs are allowed on the first scheduling cell and the second scheduling cell, in response to the first scheduling cell being determined to be different from the second scheduling cell.

25. The UE of claim 18, wherein the one or more processors is further configured to:
determine a first index value corresponding to a first control resource set of the Scell is equal to a second index value corresponding to a second control resource set of the one of the Pcell or the PScell, wherein the first index value and the second index value correspond to a UE specific search space set; and
determine one or more of the simultaneous reception of PDSCHs or the out-of-order PDSCHs or PUSCHs are not allowed, in response to the first index value being determined to be equal to the second index value.

26. A base station, comprising:
a memory storing instructions; and
one or more processors coupled with the memory and configured to:
transmit, to a user equipment (UE), configuration information for cross-carrier scheduling between a secondary cell (Scell) and one of a primary cell (Pcell) or a primary Scell (PScell);
schedule data for the one of the Pcell or the PScell for simultaneous reception of physical downlink scheduling channels (PDSCHs) and out-of-order PDSCHs or PUSCHs, based on the configuration information; and
transmit data on the one of the Pcell or the PScell according to the scheduling of the data.

27. The base station of claim 26, wherein the configuration information includes one or more cross-carrier scheduling rules based on indexes of core resource sets of the Scell and the one of the Pcell or the PScell.

28. The base station of claim 26, wherein the configuration information comprises:
instructions for the UE to allow one or more of the simultaneous reception of PDSCHs or the out-of-order PDSCHs or PUSCHs in response to a first index value corresponding to a first control resource set of the S cell being determined by the UE to be different from a second index value corresponding to a second control resource set of the one of the Pcell or the PScell.

29. The base station of claim 26, wherein the configuration information comprises:
instructions for the UE to not allow one or more of the simultaneous reception of PDSCHs or the out-of-order PDSCHs or PUSCHs in response to a first index value corresponding to a first control resource set of the S cell being determined by the UE to be equal to a second index value corresponding to a second control resource set of the one of the Pcell or the PScell.

30. The base station of claim 26, wherein the configuration information comprises:
instructions for the UE to allow one or more of the simultaneous reception of PDSCHs or the out-of-order PDSCHs or PUSCHs in response to a first index value corresponding to a first control resource set of the Scell being determined to be equal to a second index value corresponding to a second control resource set of the one of the Pcell or the PScell.
